(19) United States
(12) Patent Application Publication
(10) Pub. No.: US 2007/0243987 A1
(43) Pub. Date: Oct. 18, 2007

(54) Apparatus for folding ribbons tidily

(75) Inventors: Stefano Anelli, Lucca (IT); Simone Chelossi, Lucca (IT)

Correspondence Address: MODIANO & ASSOCIATI, Via Meravigli, 16, Milan, 20123, omitted

(73) Assignee: S-TECH S.R.L

(21) Appl. No.: 11/730,762

(22) Filed: Apr. 4, 2007

(30) Foreign Application Priority Data
Apr. 14, 2006 (IT) BO2006A000291

(51) Int. Cl. B31B 21/26

(52) U.S. Cl. 493/254

(57) ABSTRACT

An apparatus for folding ribbons tidily, particularly ribbons fed from a reel, comprising at least one support for supporting at least one first folding assembly and one second folding assembly on a main footing, and selective positioning pivots for arranging the folding assemblies with respect to the footing in respective mutually exclusive operating configurations, so as to allow the preset tidy folding of at least one ribbon according to the required processing needs.

The present invention relates to an apparatus for folding ribbons tidily.

### BACKGROUND OF THE INVENTION

In many fields of production, the need is felt to fold tidily in a predefined manner a continuous ribbon so as to allow further processing thereof. For example in production lines of paper products such as tissues, napkins and the like, the continuous paper ribbons are conveniently folded, according to preset configurations, by means of a suitable folding assembly of a known type, which is provided with rollers and geometric folding plates which are arranged conveniently so as to allow the subsequent cutting and stacking steps up to packaging.

The continuous ribbon, unwound from a reel, passes along the production line through successive processing stations and generally passes through a first embossing station to be then fed to the folding assembly, downstream of which the subsequent stations, designed for example for stacking and cutting, are located. Usually, the folding assembly is supported on a footing above the subsequent processing stations.

Depending on the final product to be provided, a specific folding of the ribbons is required, and therefore the folding assembly must be replaced along the production line or at least its components, or some of them, must be repositioned and adjusted each time according to specific requirements.

Traditionally, the replacement or adaptation of the folding assembly is performed manually by specialized workers, who disassemble, replace or redistribute and adjust the rollers, the geometric plates and the other components of the assembly. However, performing these operations requires a long time, during which the production line necessarily is inactive, with obvious economic disadvantages, also because the intervention of the workers to prepare different folding assemblies of course entails considerable costs.

### SUMMARY OF THE INVENTION

The aim of the present invention is to solve the above mentioned problems, by providing an apparatus for folding ribbons tidily which allows to reduce the times for differentiated ribbon folding, with gains also in economic terms.

Within this aim, an object of the invention is to provide an apparatus which, by way of its particular constructive characteristics, is capable of giving the greatest assurances of reliability and safety in use.

Another object of the present invention is to provide an apparatus which is simple, relatively easy to provide in practice, effective in operation, and also competitive from an economic standpoint.

This aim and these and other objects which will become better apparent hereinafter are achieved by an apparatus for folding ribbons tidily, particularly ribbons fed from a reel, characterized in that it comprises at least one support for supporting at least one first folding assembly and one second folding assembly on a main footing, and selective positioning means for arranging said folding assemblies with respect to said footing in respective mutually exclusive operating configurations, so as to allow the preset tidy folding of at least one ribbon according to the required processing needs.

### BRIEF DESCRIPTION OF THE DRAWINGS

Further characteristics and advantages of the invention will become better apparent from the following detailed description of a preferred but not exclusive embodiment of an apparatus for folding ribbons tidily according to the invention, illustrated by way of non-limiting example in the accompanying drawings, wherein:

FIG. 1 is a front view of an apparatus for folding ribbons tidily according to the invention;

FIG. 2 is a plan view of the apparatus according to the invention;

FIG. 3 is a perspective view of the apparatus according to the invention;

FIG. 4 is a perspective view, taken from another angle, of the apparatus according to the invention.

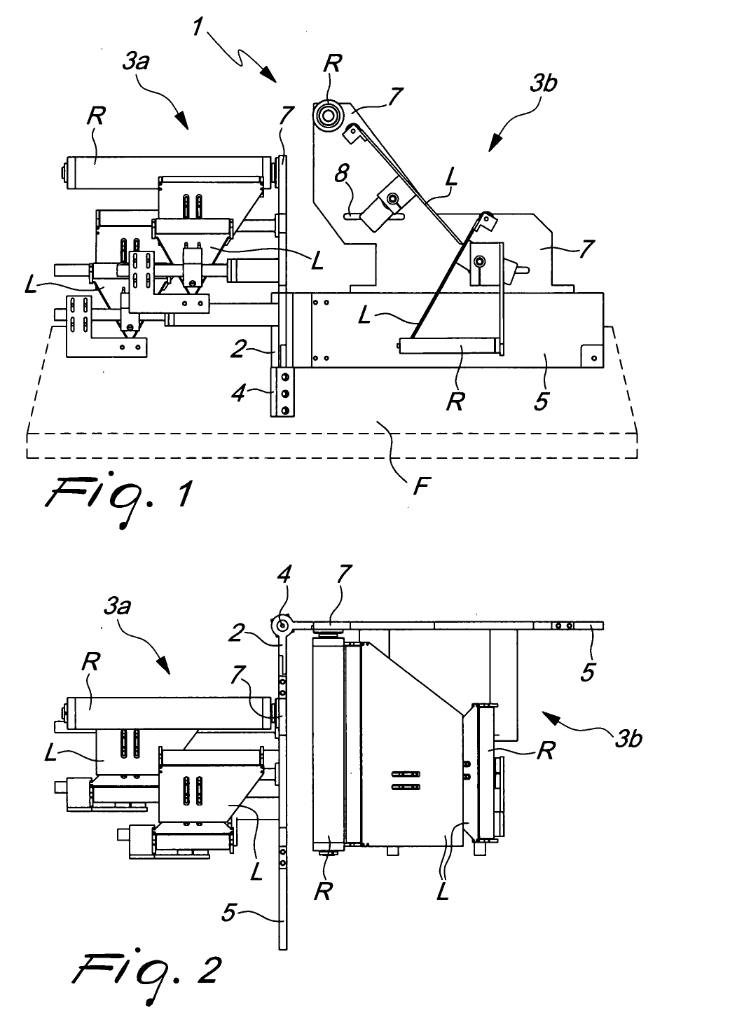

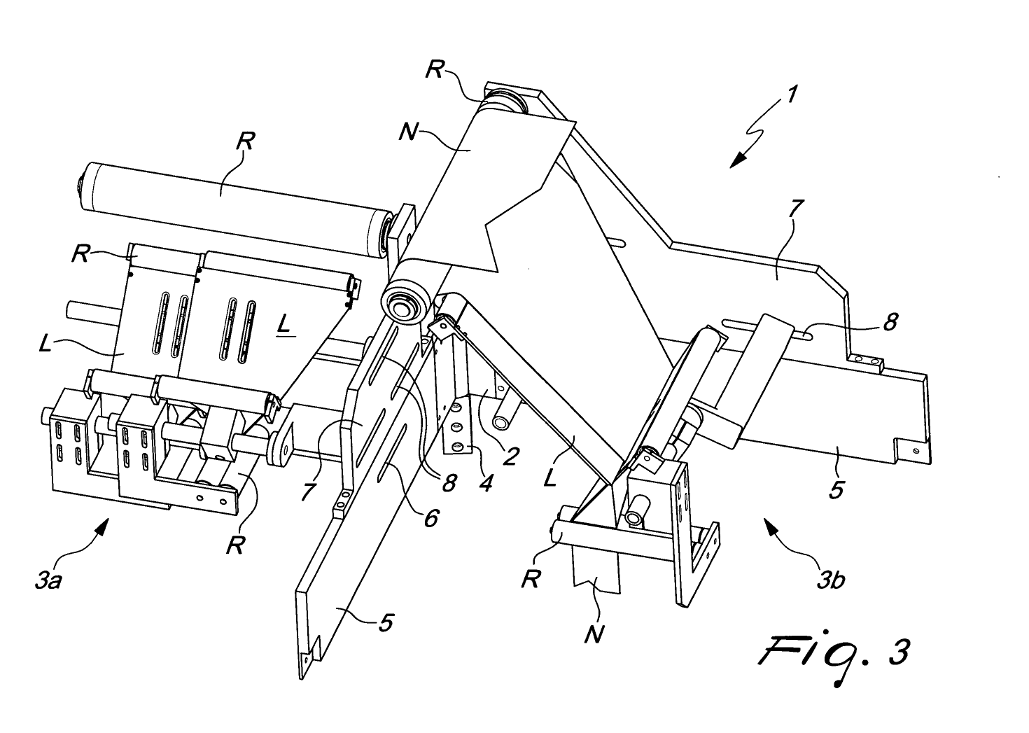

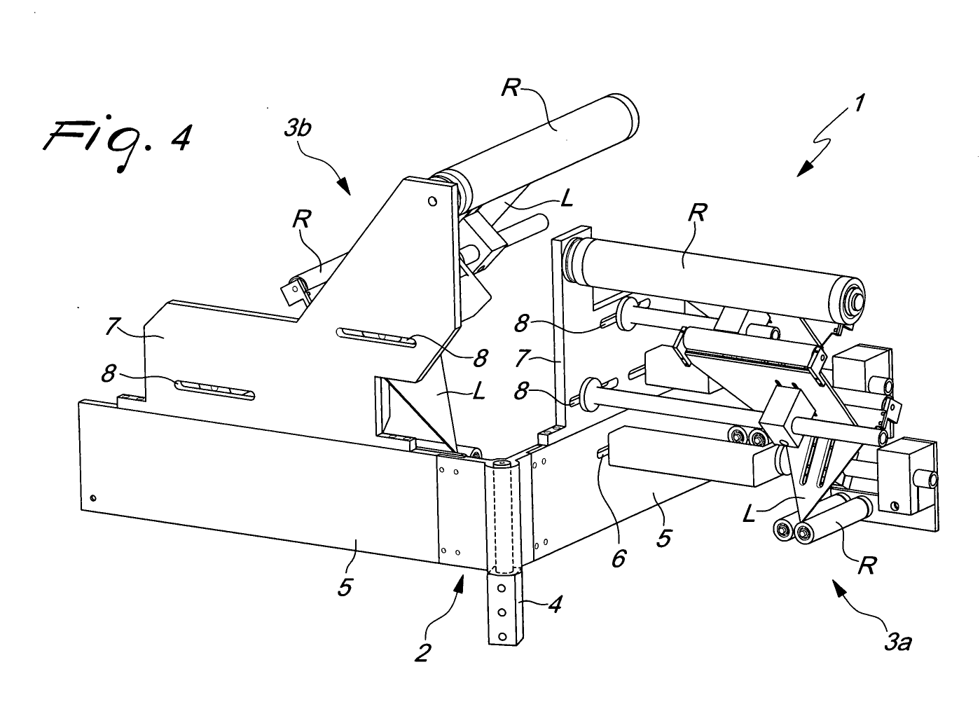

### DESCRIPTION OF THE PREFERRED EMBODIMENTS

With reference to the figures, the reference numeral 1 generally designates an apparatus for folding ribbons tidily according to the invention.

The apparatus 1 for folding ribbons N tidily, particularly ribbons fed from a reel, comprises a support 2 for supporting at least one first folding assembly 3a and one second folding assembly 3b on a main footing F, and also comprises selective positioning means 4 for the arrangement of the assemblies 3a, 3b with respect to the footing in respective mutually exclusive operating configurations, so as to allow the preset tidy folding of at least one ribbon N according to the required processing needs.

Advantageously, the selective positioning means 4 comprise a rotation pivot, which is associated by one, first end with the support 2 of the folding assemblies 3a, 3b and by the other, second end with the footing, so as to allow the selective rotation of the assemblies 3a, 3b with respect to the footing in an operating configuration for at least one of them according to the required processing needs. In particular, the folding assemblies 3a, 3b can rotate selectively with the support 2 about the substantially vertical axis of the pivot 4.

The selective rotation of the assemblies 3a, 3b about the axis of the pivot 4 can be performed manually, by way of suitable manual elements (not shown in the figures), or also automatically, by way of appropriate automatic elements (not shown in the figures), which comprise for example a gearmotor assembly which is associated with the pivot 4.

Positively, the support 2 comprises at least two plate-like walls 5, which are angularly spaced by a predefined angle and are affected by, i.e. comprise, slots 6 in the form of mounting through slots which are adapted to allow the mounting of the components of the folding assemblies 3a, 3b on the walls 5.

Conveniently, there are also panels 7 which are associated/connected with the walls 5 and are affected by, i.e. comprise further mounting slots 8 which are adapted to allow the mounting of the components of the folding assemblies 3a, 3b on the panels 7.

Said components are constituted for example by rollers R and geometric folding plates L, and other elements, which are conveniently assembled so as to provide assemblies 3a, 3b which are already in the active configuration and adjusted and are adapted to allow a specific folding of the ribbon N.

In practical operation, the apparatus 1 is arranged along a production line, for example of paper products such as tissues, napkins and the like, and receives the continuous paper ribbon N directly from a reel or from a processing station arranged upstream (for example an embossing station).

The apparatus 1, supported on the footing above subsequent processing stations, allows the adequate folding of the ribbon N according to the required processing by means of a specific folding assembly 3a, 3b which is arranged in the active configuration, so as to allow its subsequent processing steps, for example for cutting and stacking, in the dedicated stations located downstream.

The exemplary embodiment illustrated in the figures shows a first folding assembly 3a and a second folding assembly 3b, but nevertheless in other exemplary embodiments the apparatus 1 might comprise a plurality of folding assemblies which are associated with the support 2 so that they can rotate selectively on the footing, are already in an active condition and are adjusted so as to perform a specific folding of the ribbon N according to processing requirements.

If a different folding of the ribbon N is required, it is sufficient to turn the assemblies about the pivot 4, so as to bring to the active configuration the specific assembly which is adapted to perform the required folding, without having to remove and replace completely an assembly or have at least to reposition and adjust again the components, as occurs traditionally, with evident advantages in terms of time.

In practice it has been found that the invention fully achieves the intended aim and objects, since the apparatus 1 allows any tidy folding of ribbons N, reducing processing times, with gains also in economic terms.

The invention thus conceived is susceptible of numerous modifications and variations, all of which are within the scope of the appended claims; all the details may further be replaced with other technically equivalent ones.

In the exemplary embodiments shown, individual characteristics, given in relation to specific examples, may actually be interchanged with other different characteristics that exist in other exemplary embodiments.

Moreover, it is noted that anything found to be already known during the patenting process is understood not to be claimed and to be the subject of a disclaimer.

In practice, the materials used, as well as the shapes and dimensions, may be any according to requirements and to the state of the art without thereby abandoning the scope of the protection of the appended claims.

The disclosures in Italian Patent Application No. BO2006A000291 from which this application claims priority are incorporated herein by reference.

What is claimed is:

1. An apparatus for tidily folding ribbons that are fed from a reel, comprising: a main footing; at least one support on the main footing; at least one first folding assembly and one second folding assembly supported on said support; selective positioning means on said footing for arranging said first and second folding assemblies with respect to said footing in respective mutually exclusive operating configurations, so as to allow a preset tidy folding of at least one ribbon according to a required processing need.

2. The apparatus of claim 1, wherein said selective positioning means comprise at least one rotation pivot, which is associated by a first end thereof with said first and second folding assemblies and by a second end thereof with said footing, for a selective rotation of said first and second folding assemblies with respect to said footing in an active configuration for at least one of said first and second folding assemblies according to the required processing needs.

3. The apparatus of claim 2, wherein said selective positioning means comprise one said rotation pivot which is associated by the first end with said support and by the second end with said footing, said first and second folding assemblies being able to rotate selectively with said support to perform a selective rotation about a substantially vertical axis of said pivot.

4. The apparatus of claim 3, comprising manual elements for controlling the selective rotation of said first and second folding assemblies about the axis of said pivot.

5. The apparatus of claim 3, comprising automatic elements for controlling the selective rotation of said first and second folding assemblies about the axis of said pivot.

6. The apparatus of claim 5, wherein said automatic elements comprise a gearmotor assembly which is associated with said pivot.

7. The apparatus of claim 1, wherein said support comprises at least two plate shaped walls, which are angularly spaced by a predefined angle and comprise mounting slots which are adapted to allow mounting of components of said first and second folding assemblies on said plate shaped walls.

8. The apparatus of claim 7, further comprising panels which are associated with said plate shaped walls and comprise further mounting slots which are adapted to allow mounting of the components of said first and second folding assemblies on said panels.
